(19) United States
(12) Patent Application Publication
(10) Pub. No.: US 2025/0366667 A1
(43) Pub. Date: Dec. 4, 2025

(54) FOOD PROCESSOR ATTACHMENT ASSEMBLY FOR A STAND MIXER

(71) Applicant: Haier US Appliance Solutions, Inc., Wilmington, DE (US)

(72) Inventors: Jaebong Lee, Seongnam-si (KR); Dong Soo Shin, Seoul (KR)

(21) Appl. No.: 18/677,377

(22) Filed: May 29, 2024

(51) Int. Cl. A47J 43/07; A47J 43/08

(52) U.S. Cl. CPC A47J 43/0711; A47J 43/082

(57) ABSTRACT

A stand mixer includes a base, a support column coupled to the base and extending upwardly from the base, a head coupled to an upper end of the support column and extending from the support column above the base, a drive shaft, and a food processor attachment assembly. The food processor attachment assembly includes a housing defining a chamber therein and including an inlet for receiving food within the chamber for processing and an outlet, a moveable component positioned within the chamber for manipulating the food during processing, and a multi-axis rotatable joint coupled between the movable component and the drive shaft for transferring rotational motion from the drive shaft to the moveable component to move the moveable component.

### FIELD OF THE INVENTION

The present disclosure relates generally to stand mixers, or more specifically, to the food processor attachment assembly of a stand mixer.

### BACKGROUND OF THE INVENTION

Stand mixers are generally used for performing automated mixing, churning, or kneading involved in food preparation. Typically, stand mixers include a motor configured to provide torque to one or more drive shafts. Users may connect various utensils to the one or more drive shafts, including whisks, spatulas, or the like. Such utensil types connected to the driveshaft(s) often include various auxiliary attachment assemblies, such as food processor attachment assemblies. While such food processor attachment assemblies work well, further improvements are needed.

Accordingly, a stand mixer having a food processor attachment assembly would be desirable. More specifically, a food processor attachment assembly with moveable components capable of being rotated about alternative axes would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a stand mixer is provided. The stand mixer includes a base, a support column coupled to the base and extending upwardly from the base, a head coupled to an upper end of the support column and extending from the support column above the base, a drive shaft, and a food processor attachment assembly coupled to the head of the stand mixer for receiving food for processing. The food processor attachment assembly includes a housing defining a chamber therein and including an inlet for receiving the food within the chamber for processing and an outlet, a moveable component positioned within the chamber for manipulating the food during processing, and a multi-axis rotatable joint coupled between the movable component and the drive shaft for transferring rotational motion from the drive shaft to the moveable component to move the movable component.

In another example aspect, a food processor attachment assembly for a stand mixer is provided. The food processor attachment assembly includes a base, a support column coupled to the base and extending upwardly from the base, a head coupled to an upper end of the support column and extending from the support column above the base, and a drive shaft. The food processor attachment assembly includes a housing defining a chamber therein and including an inlet for receiving the food within the chamber for processing and an outlet, a moveable component positioned within the chamber for manipulating the food during processing, and a multi-axis rotatable joint coupled between the movable component and the drive shaft for transferring rotational motion from the drive shaft to the moveable component to move the movable component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an example embodiment of a stand mixer of the present disclosure.

FIG. 2 is a perspective view of an example embodiment of a food processor attachment assembly.

FIG. 3 is a side, partially exploded, cross-sectional view of the example food processor attachment assembly of FIG. 2 and the example stand mixer of FIG. 1.

FIG. 4 is a perspective view of a different example embodiment of a food processor attachment assembly.

FIG. 5 is a perspective view of an example embodiment of an example outlet cover of the example food processor attachment assembly of FIG. 4.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

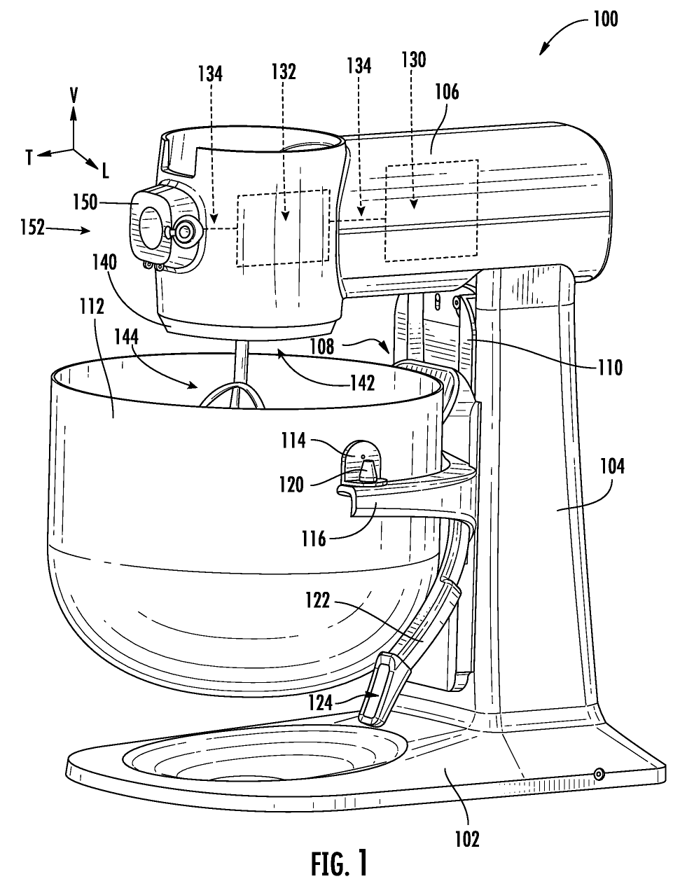

FIG. 1 provides a perspective view of a stand mixer 100 according to an example embodiment of the present subject matter. It will be understood that stand mixer 100 is provided by way of example only and that the present subject matter may be used in or with any suitable stand mixer in alternative example embodiments. Moreover, with reference to FIG. 1, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

Stand mixer 100 may include a base 102 and a support post or column 104. Column 104 may include a bowl support 108. Bowl support 108 may slidably mount to a column rail 110, which is mounted to column 104. Additionally, components of bowl support 108 may extend outwardly above the base 102, e.g., in the transverse direction T, and may hold bowl 112 above base 102, e.g., along the vertical direction V. Bowl 112 may be removably mounted on bowl support 108 via flanges 114. Flanges 114 may be on opposite sides of the bowl 112 with respect to the circumference of the bowl.

Additionally, the support column 104 may support a mixer head 106, which is positioned atop column 104. The mixer head 106 may house a motor 130, a gearbox 132, and/or a drivetrain apparatus 134 of stand mixer 100. For example, as shown in FIG. 1, head 106 may be mounted to column 104, which is mounted to base 102. Thus, column 104 may extend between and connect base 102 and head 106, e.g., along the vertical direction V. Head 106 may extend outwardly above the base 102, e.g., in the transverse direction T.

Furthermore, head 106 includes a mixing attachment support 140. Mixing attachment support 140 is located on a lower portion or underside 142 of head 106 and forward of support column 104 along transverse direction T. A rotating mixing attachment 144 is removably coupled to the mixing attachment support 140. The drivetrain apparatus 134 connects the motor 130 with the gearbox 132 and the mixing attachment support 140 such that the motor 130 may drive rotation of the mixing attachment 144 when the mixing attachment 144 is coupled to the mixing attachment support 140. The gearbox 132 may allow user selection of different rotating speeds for the mixing attachment 144. The stand mixer 100 may include one or more controls for operations such as selectively powering the motor 130, choosing the speed of rotation for the mixing attachment 144, and other features. In certain embodiments, the mixing attachment support 140 may accept more than one type of mixing attachment 144. Various types of mixing attachments may be used including e.g., whisks, paddles, dough hooks, beaters, and others for purposes of mixing ingredients within a bowl or other container supported by the base 102. During use, rotation of the mixing attachment 144 may be driven in a circular or planetary manner. Spinning in a planetary manner, as used herein, includes spinning both in a circular manner and rotating about an axis that moves in a circular manner. In some embodiments, the motor 130 may be disposed within base 102, including within the column 104.

Example operation of an exemplary embodiment of the stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on a motor to begin the process of mixing, kneading, beating, etc. The motor rotates an attachment attached to stand mixer 100 to complete each of these processes. The processes may be conducted with a respective attachment such as a mixer blade for mixing, a dough hook for kneading, and a balloon whisk for beating.

As shown in FIG. 1, bowl support 108 may include an arm 116, with a mounting spike 120. Arm 116 may hold bowl 112 via mounting spike 120, which may removably couple to flanges 114. For instance, each mounting spike 120 on arm 116 may be received within a respective flange 114 on bowl 112. Lift lever 122 may rotatably couple to arm 116. There may be at least two lift levers 122. Thus, bowl 112 may be disposed between lift levers 122, e.g., along the lateral direction L. Each lift lever 122 may be positioned on a respective side of bowl 112, such that both a left-handed user and a right-handed user may comfortably operate lift levers 122. Lift lever 122 may have one end 124 cantilevered from support column 104. Such distal end 124 may correspond to a handle for a user to grasp, push, or pull.

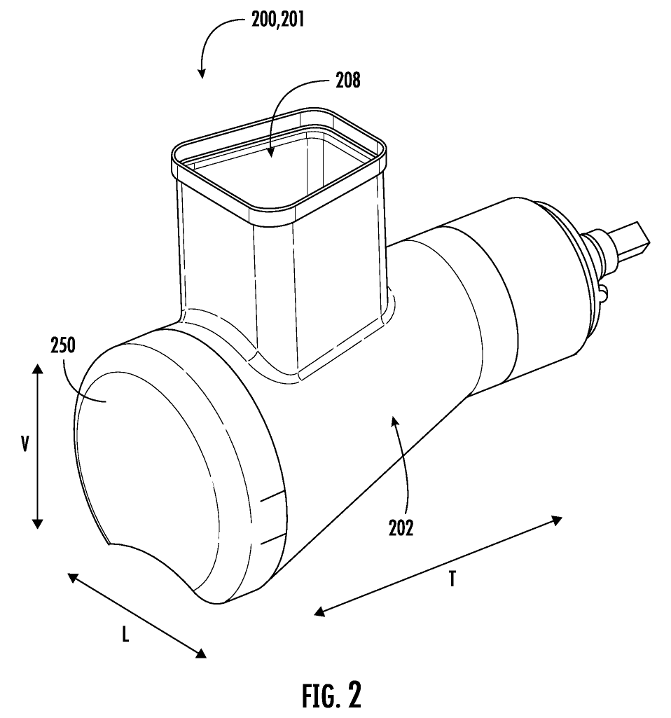

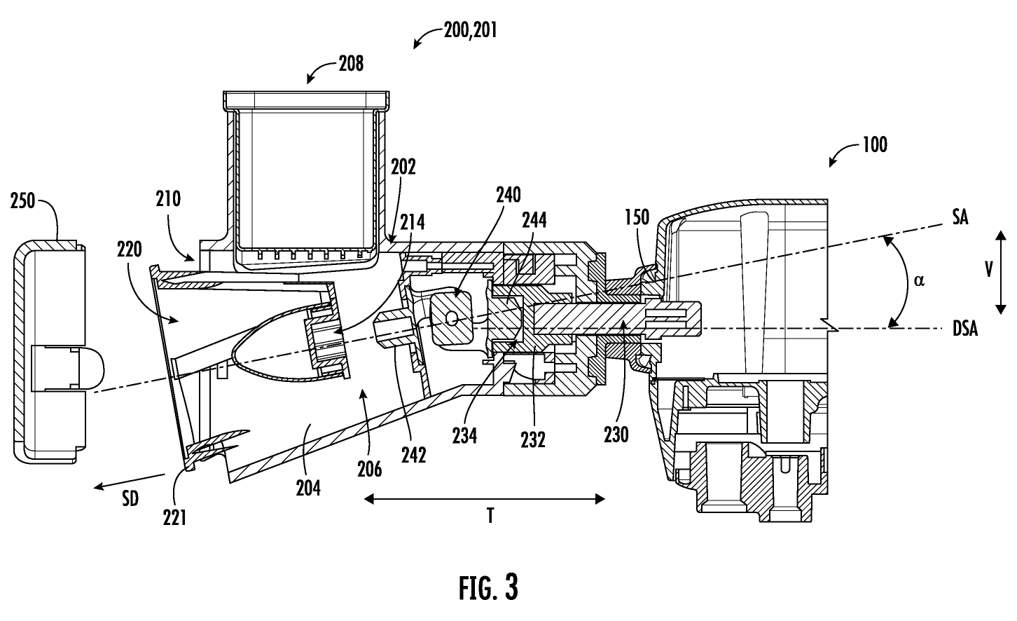

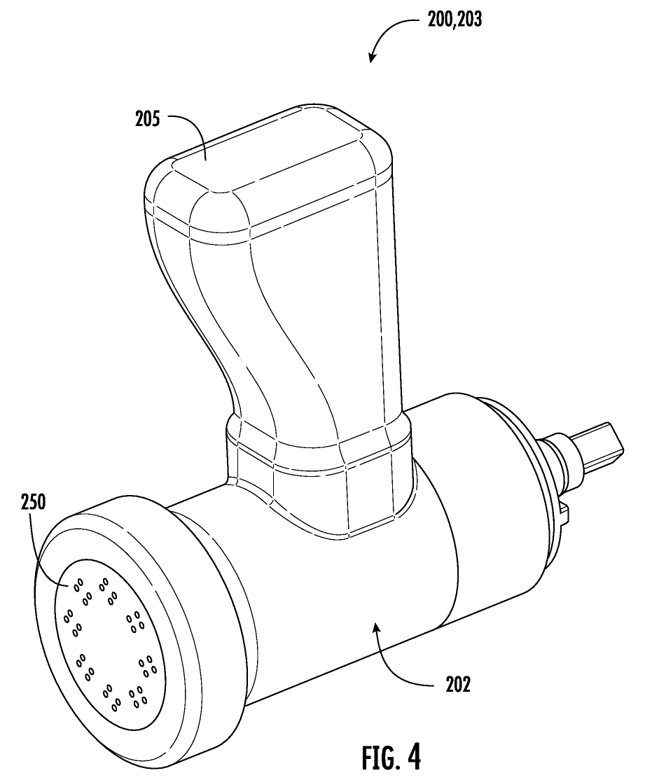

Furthermore, as shown in FIG. 1, the head 106 includes an auxiliary attachment support 150 located on a forward portion or frontside 152 of head 106 in the transverse direction T and forward of support column 104 in the transverse direction T. A food processor attachment assembly 200 (FIGS. 2-4) for processing food, may be removably coupled to the auxiliary attachment support 150 (FIG. 3). For example, a removable pin (not shown) may couple the food processor attachment assembly 200 to the auxiliary attachment support 150. The drivetrain apparatus 134 connects the motor 130 with the gearbox 132 and the auxiliary attachment support 150 such that the motor 130 may drive rotation of various components of the food processor attachment assembly 200 when the food processor attachment assembly 200 is coupled to the auxiliary attachment support 150. In certain embodiments, the auxiliary attachment support 150 may accept more than one type of auxiliary attachment assembly. For example, various types of food processor attachment assemblies may be used including e.g., food slicer attachments (FIGS. 2, 3), dough mold attachments (FIG. 4), and others for purposes of processing food.

Referring now to FIGS. 2 through 5, the food processor attachment assembly 200 that may be used with the stand mixer 100 will be described according to example embodiments of the present subject matter.

According to example embodiments, the food processor attachment assembly 200 may include a hopper or housing 202, which, as will be described below, may also house various other components of the food processor attachment assembly 200 used to process food. In some embodiments, the food processor attachment assembly 200 may be a food slicer attachment assembly for slicing unsliced food into sliced food, such as the example food slicer attachment 201 assembly illustrated in FIGS. 2 and 3. However, as will be described below, the food processor attachment assembly 200 may be another type of food processor attachment assembly, such as a dough mold attachment assembly. Notably, as best illustrated in FIG. 3, the housing 202 of the food slicer attachment assembly 201 includes an inner wall 204 that defines an interior portion or chamber 206 of the housing 202. Additionally, the housing 202 includes an inlet 208 for receiving the unprocessed/unsliced food within the chamber 206 of the housing 202 through which it will travel and be processed/sliced. The housing 202 also includes an outlet 210 for releasing the processed/sliced food from the housing 202 when an outlet cover 250, which will be described below, of the food slicer attachment assembly 201 is removed. The inlet 208 may be an inlet opening defined by the housing 202 for receiving the unprocessed/unsliced food and the outlet 210 may be an outlet opening defined by the housing 202 for releasing the processed/sliced food therefrom. The food slicer attachment assembly 201 may be coupled to the head 106 of the stand mixer 100 such that the inlet 208 is positioned above the chamber 206 of the housing 202 in the vertical direction V. In this respect, gravity may act on the unprocessed/unsliced food, thereby pulling the food into the chamber 206.

As best illustrated in FIG. 3, the food slicer attachment assembly 201 may also include a moveable component, such as a rotatable food slicer 220 for slicing unsliced food into sliced food. According to example embodiments, the rotatable food slicer 220 may be positioned within the chamber 206 of the housing 202. The rotatable food slicer 220 may be rotatable about slicer axis SA relative to the housing 202. Additionally, the rotatable food slicer 220 may include one or more blades 221 that cut or slice food received within the chamber 206 via the inlet 208 into sliced food as the rotatable food slicer 220 rotates.

According to example embodiments, the drive train apparatus 134 of the stand mixer 100 includes a drive shaft 230 for rotating the rotatable food slicer 220 when the food slicer attachment assembly 201 is coupled to the stand mixer 100. As such, the housing 202 of the food slicer attachment assembly 201 may define a drive shaft opening 214 for receiving the drive shaft 230 therethrough. The food slicer attachment assembly 201 may include a multi-axis rotatable joint 240 positioned within the chamber 206 of the housing 202 for coupling the drive shaft 230 to the rotatable food slicer 220 when the drive shaft 230 is received through the drive shaft opening 214.

Notably, the multi-axis rotatable joint 240 may transfer rotational motion from the drive shaft 230, which rotates about drive shaft axis DSA, to the rotatable food slicer 220 to rotate the rotatable food slicer 220 about slicer axis SA, which is different from drive shaft axis DSA. For example, as best illustrated in FIG. 3, the drive shaft axis DSA and the slicer axis SA may be positioned relative to each other such that an angle α is defined between the drive shaft axis DSA and the slicer axis SA. As such, the multi-axis rotatable joint 240 may include a first joint connector 242 aligned with and received within a joint connector opening 222 defined within the rotatable food slicer 220 for coupling the food slicer 220 to the multi-axis rotatable joint 240. As such, the first joint connector 242 is rotatable about the slicer axis SA as the drive shaft 230 rotates the multi-axis joint 240 and, thus, the food slicer 220. The first joint connector 242 and the joint connector opening 222 may have similarly complementary cross-sectional shapes that may allow the multi-axis rotatable joint 240 to pull or rotate the food slicer 220 simultaneously with the multi-axis rotatable joint 240 and, thus, the drive shaft 230.

Likewise, the multi-axis rotatable joint 240 may include a second joint connector 244 coupled or otherwise connected to the first joint connector 242. The second joint connector 244 may be aligned with and received within an end cap opening 234 of a drive shaft end cap 232 for coupling the drive shaft 230 to the multi-axis rotatable joint 240. As such, the second joint connector 244 is rotatable about the drive shaft axis DSA as the drive shaft 230 rotates the multi-axis joint 240 and, thus, the food slicer 220. The second joint connector 244 and the end cap opening 234 may have complementary cross-sectional shapes, such as “D” shapes (not shown) or rectangular shapes (not shown), that allow the drive shaft 230 to pull or rotate the multi-axis rotatable joint 240 simultaneously with the drive shaft 230. Likewise, the first joint connector 242 and the joint connector opening 222 may have similarly complementary cross-sectional shapes that may allow the multi-axis rotatable joint 240 to pull or rotate the food slicer 220 simultaneously with the multi-axis rotatable joint 240 and, thus, the drive shaft 230. Additionally, the complementary cross-sectional shapes may limit or prevent the multi-axis rotatable joint 240, the drive shaft 230, and the food slicer 220 from rotating relative to each other during simultaneous rotation.

According to example embodiments, the food slicer attachment assembly 201 may include an outlet cover 250. The outlet cover 250 may be removably coupled to the housing 202 of the food slicer attachment assembly 201 and cover the outlet 210 of the housing 202. Additionally, the outlet cover 250 may hold the food slicer 220 within the chamber 206 of the housing 202. For example, in some embodiments, the food slicer 220 may slide away from the multi-axis rotatable joint 240 in the sliding direction SD when the outlet cover 250 is removed from the housing 202, even when the first connector 242 of the multi-axis rotatable joint 240 is received within the joint connector opening 222 of the food slicer 220. In such scenarios, when the outlet cover is removed from the housing 202 and the food slicer 220 slides away from the multi-axis rotatable joint 240, the food slicer 220 is not coupled to the multi-axis rotatable joint 240 and, thus, not rotatable by the multi-axis rotatable joint 240. However, when the outlet cover 250 is coupled to the housing 202 (FIG. 2), the outlet cover 250 may hold the food slicer 220 in place such that the food slicer 220 is coupled to the multi-axis rotatable joint 240 and, thus, rotatable by the multi-axis rotatable joint 240.

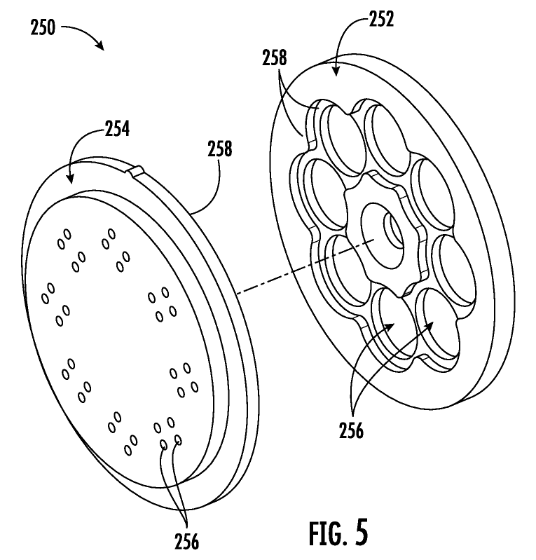

According to alternative example embodiments, the food processor attachment assembly 200 may be a dough mold attachment assembly, such as the example dough mold attachment assembly 203 illustrated in FIG. 4. As shown in FIG. 4, the dough mold attachment assembly 203 may be configured as a dough mold attachment assembly for forming moldable dough into molded pasta shapes. The housing 202 of the dough mold attachment assembly 203 may house various components of the dough mold attachment assembly 203 used to form moldable dough into molded dough, such as a dough auger (not shown) for moving the moldable dough through the housing 202. Similar to the food slicer attachment assembly 201, the housing 202 of the dough mold attachment assembly 203 may define an interior portion or chamber (not shown). Additionally, similar to the food slicer attachment assembly 201, the housing 202 of the dough mold attachment assembly 203 includes the inlet (not shown in FIG. 4), which may be covered by a removable cover 205 as shown in FIG. 4, for receiving the moldable dough therein. The housing 202 also includes the outlet 210 for releasing the moldable dough food from the housing 202 into the outlet cover 250, which, as shown in FIG. 5, may be configured as a pasta extruder for forming the moldable dough into molded dough, such as molded pasta shapes.

As best illustrated in FIG. 5, the outlet cover 250 may include a first dough extruding component 252 and a second dough extruding component 254, which may be configured as dough extruding components for extruding moldable dough into molded pasta shapes. Each dough extruding component 252, 254 may define various extrusion openings 256 through which the moldable dough passes through and formed into the shape of the corresponding extrusion opening 256 as it passes through the extrusion opening 256. As such, dough passes between the first dough extruding component 252 and the second dough extruding component 254 before exiting the dough mold attachment assembly 203, sometimes leaving behind dough fragments between the first and second dough extruding components 252, 254. Additionally, the first dough extruding component 252 and the second dough extruding component 254 may be removably coupled to each other for accessing an interior portion 258 of each dough extruding component 252, 254. As such, users may access and remove dough fragments left behind between the dough extruding components 252, 254.

As explained herein, aspects of the present subject matter are generally directed to a food processor attachment assembly of a stand mixer that includes a housing defining a chamber therein, the housing including an inlet for receiving food within the chamber for processing and an outlet. Additionally, the food processor attachment assembly includes a moveable component positioned within the chamber for manipulating the food during processing. Furthermore, the food processor attachment assembly includes a multi-axis rotatable joint coupled between the movable component and the drive shaft for transferring rotational motion from the drive shaft to the moveable component to move the movable component. Additionally, in some embodiments, the food processor attachment assembly may include an outlet cover for containing the moveable component within the chamber of the housing. This food processor attachment assembly that is usable with a stand mixer may advantageously provide rotation of the moveable component about an axis different from the rotational axis by which it is driven, for example, the axis about which the drive shaft of the stand mixer rotates. Additionally, this food processor attachment assembly may advantageously provide an outlet cover that holds the moveable component in place within the chamber to be rotated by the drive shaft of the stand mixer while the outlet cover is coupled to the housing. The moveable component is not held within the chamber and not rotatable by the drive shaft of the stand mixer when the outlet cover is not coupled to the housing thus providing a safety mechanism to prevent users from accessing the moveable component while it is rotating. Furthermore, in some embodiments, this food processor attachment assembly may advantageously provide an outlet cover with dough extruding components removably coupled to each other for providing access to interior portions of the dough extruding components. As such, the interior portions of the dough extruding components of the outlet cover are easier to clean.

In addition to rotation of the dough mold, a dough feeder block and a linear actuator may assist with moving the moldable dough toward the rotatable dough mold. Thereafter, the moldable dough is moved through a gap between the inner wall of the dough hopper and the dough mold and shaped and cut as the mold cavity(ies) form the moldable dough into molded dough, such as individual molded cookie dough pieces for baking. This dough mold attachment assembly that is usable with a stand mixer may advantageously provide molding or forming cookie dough into cookie shapes for baking so that separate tools/machinery are not necessary. A user may thus use the machinery they already own or have access to (i.e., stand mixer) to mold cookie dough.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer, comprising:
a base;
a support column coupled to the base and extending upwardly from the base;
a head coupled to an upper end of the support column and extending from the support column above the base;
a drive shaft;
a food processor attachment assembly coupled to the head of the stand mixer for receiving food for processing, the food processor attachment assembly comprising:
a housing defining a chamber therein, the housing including an inlet for receiving the food within the chamber for processing and an outlet;
a moveable component positioned within the chamber for manipulating the food during processing; and
a multi-axis rotatable joint coupled between the moveable component and the drive shaft for transferring rotational motion from the drive shaft to the moveable component to move the moveable component.

2. The stand mixer of claim 1, the food processor attachment further comprising:
an outlet cover coupled to the housing for covering the outlet and containing the moveable component within the chamber of the housing.

3. The stand mixer of claim 2, wherein:
the movable component is coupled to the multi-axis rotatable joint; and
the outlet cover holds the moveable component in place such that the movable component is coupled to the multi-axis rotatable joint while the outlet cover is coupled to the housing.

4. The stand mixer of claim 1, wherein:
the moveable component of the food processor attachment is rotatable about a first axis of rotation for manipulating the received food during processing; and
the drive shaft is rotatable about a second axis of rotation different from the first axis of rotation.

5. The stand mixer of claim 4, wherein:
the multi-axis rotatable joint is configured to rotate the movable component about the first axis of rotation as the drive shaft rotates the multi-axis rotatable joint about the second axis of rotation.

6. The stand mixer of claim 4, the multi-axis rotatable joint comprising:
a first joint connector coupled to the moveable component, the first joint connector rotatable about the first axis of rotation when the multi-axis rotatable joint is rotated; and
a second joint connector coupled to the drive shaft and the first joint connector, the second joint connector rotatable about the second axis of rotation when the multi-axis rotatable joint is rotated.

7. The stand mixer of claim 1, wherein:
the food processor attachment assembly is configured as a food slicer attachment assembly; and
the moveable component of the food processor attachment assembly is configured as a rotatable blade for slicing the received food into sliced food.

8. The stand mixer of claim 1, wherein:
the food processor attachment assembly is configured as a dough mold attachment assembly for forming moldable dough into molded dough.

9. The stand mixer of claim 8, the dough mold attachment comprising:
an outlet cover coupled to the housing for covering the outlet and containing the moveable component within the chamber of the housing, the outlet cover including a first dough extruding component and a second dough extruding component through which the moldable dough passes through to be formed into molded dough, the first dough extruding and the second dough extruding component removably coupled to each other.

10. The stand mixer of claim 1, wherein:
the food processor assembly is removably coupled to the head.

11. A food processor attachment assembly for a stand mixer, the stand mixer including a base, a support column coupled to the base and extending upwardly from the base, a head coupled to an upper end of the support column and extending from the support column above the base, and a drive shaft, the food processor attachment assembly comprising:
a housing defining a chamber therein, the housing including an inlet for receiving food within the chamber for processing and an outlet;
a moveable component positioned within the chamber for manipulating the food during processing; and
a multi-axis rotatable joint coupled between the moveable component and the drive shaft for transferring rotational motion from the drive shaft to the moveable component to move the moveable component.

12. The food processor attachment assembly of claim 11, further comprising:
an outlet cover coupled to the housing for covering the outlet and containing the moveable component within the chamber of the housing.

13. The food processor attachment assembly of claim 12, wherein:
the movable component is coupled to the multi-axis rotatable joint; and
the outlet cover holds the moveable component in place such that the movable component is coupled to the multi-axis rotatable joint while the outlet cover is coupled to the housing.

14. The food processor attachment assembly of claim 11, wherein:
the moveable component is rotatable about a first axis of rotation for manipulating the received food during food processing; and
the drive shaft is rotatable about a second axis of rotation different from the first axis of rotation.

15. The food processor attachment assembly of claim 14, wherein:
the multi-axis rotatable joint is configured to rotate the movable component about the first axis of rotation as the drive shaft rotates the multi-axis rotatable joint about the second axis of rotation.

16. The food processor attachment assembly of claim 14, the multi-axis rotatable joint comprising:
a first joint connector coupled to the moveable component, the first joint connector rotatable about the first axis of rotation when the multi-axis rotatable joint is rotated; and
a second joint connector coupled to the drive shaft and the first joint connector, the second joint connector rotatable about the second axis of rotation when the multi-axis rotatable joint is rotated.

17. The food processor attachment assembly of claim 11, wherein:
the food processor attachment assembly is configured as a food slicer attachment assembly; and
the moveable component is configured as a rotatable blade for slicing the received food into sliced food.

18. The food processor attachment assembly of claim 11, wherein:
the food processor attachment assembly is configured as a dough mold attachment assembly for forming moldable dough into molded dough.

19. The food processor attachment assembly of claim 18, further comprising:
an outlet cover coupled to the housing for covering the outlet and containing the moveable component within the chamber of the housing, the outlet cover including a first dough extruding component and a second dough extruding component through which the moldable dough passes through to be formed into molded dough, the first dough extruding and the second dough extruding component removably coupled to each other.
